(19) United States
(12) Patent Application Publication
(10) Pub. No.: US 2025/0310366 A1
(43) Pub. Date: Oct. 2, 2025

(54) AUTO-GENERATED DATA GATHERING IN MANAGED NETWORKS

(71) Applicant: Ivanti, Inc., South Jordan, UT (US)

(72) Inventors: Robin Rowe, Daresbury (GB); Yun San Fung, Vancouver (CA)

(73) Assignee: Ivanti, Inc., South Jordan, UT (US)

(21) Appl. No.: 19/095,777

(22) Filed: Mar. 31, 2025

Related U.S. Application Data
(60) Provisional application No. 63/572,844, filed on Apr. 1, 2024.

(51) Int. Cl. H04L 9/40; H04L 41/16; H04L 41/5074

(52) U.S. Cl. CPC H04L 63/1425; H04L 41/16; H04L 41/5074

(57) ABSTRACT

A method for diagnosing and remediating system anomalies in a managed network using artificial intelligence (AI). The method includes receiving data from managed devices, discovering anomalies indicative of events in the network, and using an AI engine to analyze the anomalies and related data to determine additional relevant information. A data gathering mechanism is generated based on the AI engine to collect this additional information, which is then distributed to managed devices. The collected data is used to determine alterations to the network to resolve the anomalies, and these alterations are implemented in the managed network.

### CROSS REFERENCE TO RELATED APPLICATION

This application claims the benefit of and priority to U.S. Provisional App. No. 63/572,844, filed Apr. 1, 2024, which is incorporated herein by reference in its entirety.

### FIELD

The embodiments described in this disclosure are related to device management in managed networks. In particular, some embodiments are related to systems and methods for auto-generated data gathering mechanisms to mediate anomalies in managed networks.

### BACKGROUND

In large managed networks, the anomalies occur that may be indicative of a discrete or an acute technical issue being experienced by a set of users or a set of devices. Diagnostic tools directed towards these anomalies are not readily available or may require high levels of computing and administrative resources. Additionally, highly specific information may be relevant to particular users, to particular devices, or to a particular product. This information can be useful to the overall managed network, but again pulling and integrating the specific information is a resource-intensive operation.

For example, IT issues may repeat within a subset of devices, a particular user may be conducting an unauthorized process multiple times, an employee may change roles in an enterprise, etc. In these and other circumstances, gathering information from affected users may be beneficial. The resources necessary to draft, submit, receive, and analyze the response are excessive. Furthermore, because the anomaly is discrete and not widely impactful, the anomaly may go unaddressed.

In some conventional systems, surveys are employed throughout organizations. However, relevance to the individuals who receive the survey is uncertain, leading to low quality data and some individuals being over-polled, which may lead to apathy among the individuals. Moreover, some organizations use a survey templates. The templates are generic at least to some extent, which reduces the quality of the data in the responses or requires modification to the templates. Modification of the survey templates requires resource investment to adapt the template to the particular issue. Accordingly, there is a need in network management to efficiently identify and mitigate anomalies. In particular, there is a need to effectively identify anomalies and generate data gathering mechanisms that are tailored to the anomaly, which enables discrete analysis and mitigation of the anomaly without imposing unnecessary overhead on the users.

The subject matter claimed herein is not limited to embodiments that solve any disadvantages or that operate only in environments such as those described. Rather, this background is only provided to illustrate one example technology area where some embodiments described herein may be practiced.

### SUMMARY

According to an aspect of an embodiment, a method of artificial intelligence (AI)-based system anomaly diagnosis and remediation. The method may include receiving data from managed devices in a managed network. The data is indicative of device function and user interaction with managed devices. The method may include discovering an anomaly in the data. The anomaly is indicative of an event experienced at a portion of the managed network. For example, the anomaly may be indicative of a malfunctioning device or a suboptimal interaction by a user with one of the managed devices. Some examples of the anomaly may include non-use of a licensed software, a first user of a new hardware, a modification of a role of a user in the managed network, a new staff member, a change in location of a user, a repeated disabling of a firewall, or a repeated malfunction of a device such as a periodic and repetitive low battery warning. The discovering the anomaly in the data may include identifying a pattern of operations in one or more of the managed devices, identifying a pattern of operations in a software that is running on one or more of the managed devices, identifying a pattern of interoperability data related to a product update, or some combination thereof. The method may include analyzing the anomaly and data related to the anomaly to determine additional information relevant to the anomaly that is not present in the received data using an AI engine. The AI engine is trained on data of the managed network that is indicative of normal operation of the managed devices, optimal interaction of users relative to the managed devices, and optimal behavior of the managed devices. The method may include generating, based on the AI engine, a data gathering mechanism to collect the additional information. The data gathering mechanism may include a survey directed to one or more users who are associated with the anomaly and questions in the survey are directed to collection of the additional information. The data gathering mechanism may also include an identification of one or more users or one or more of the managed devices that are directly affected by the anomaly and an identification of at least one request direct to the additional information. The method may include submitting to an administrator the data gathering mechanism, wherein the distributing the data gathering mechanism is performed responsive to an indication of an approval received from the administrator. The method may include distributing the data gathering mechanism to one or more of the managed devices. The method may include receiving collected data responsive to the distributed data gathering mechanism. The method may include determining an alteration to the managed network to resolve the anomaly based on the collected data. The method may include implementing the alteration in the managed network. The anomaly may be discovered prior to submission of a ticket in a service management system and the alteration may be implemented proactively.

An additional aspect of an embodiment includes a non-transitory computer-readable medium having encoded therein programming code executable by one or more processors to perform or control performance at least a portion of the method described above.

Yet another aspect of an embodiment includes a computer device. The computer device may include one or more processors and a non-transitory computer-readable medium. The non-transitory computer-readable medium has encoded therein programming code executable by the one or more processors to perform or control performance of one or more of the operations of the methods described above.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 depicts a block diagram of an example operating environment in which some embodiments described in the present disclosure may be implemented;

FIG. 2 depicts an example process of AI-based system anomaly diagnosis and remediation that may be implemented in the operating environment of FIG. 1;

FIG. 3 illustrates an example computer system configured for AI-based system anomaly diagnosis and remediation; and

FIG. 4 is a flow chart of an example method of AI-based system anomaly diagnosis and remediation in managed network,

all according to at least one embodiment described in the present disclosure.

### DESCRIPTION OF SOME EXAMPLE EMBODIMENTS

The embodiments described in this disclosure are related to artificial intelligence (AI)-based anomaly management in managed networks. In particular, some embodiments relate to methods and systems that use an AI engine to identify the anomalies in operations of a managed network, to analyze the anomalies, gather additional information related to the anomalies, and to mitigate the anomalies.

For instance, in some embodiments, a managed network receives data and information related to the experience of users, states of the managed network, and interactions between the users and managed devices. For instance, the managed network may implement multiple management services such as service management, application management, patch management, etc. During provision of the management services, data is received regarding the management network at a fine level of granularity, such as at a user-level of granularity and/or a device-level of granularity. Accordingly, the managed network may have repositories of data that reflect normal operations of the managed network. The repositories of data provide a data set from which anomalies are identifiable through direction of the AI engine processing the repository.

For at least some of the anomalies, the repository of data may be insufficient to fully diagnose and mitigate issues causing the anomalies. Accordingly, an additional analysis may be implemented to determine the additional information effective to complete the analysis of the anomaly and generate a mitigation action.

Some embodiments of the present disclosure utilize the additional analysis to generate a data gathering mechanism. The data gathering mechanism is implemented to collect the additional information related to one of the anomalies. The data gathering mechanism is tailored to anomaly. Specifically, the data gathering mechanism is directed to affected users, affected devices, or an affected product. The data gathering mechanism is then distributed to those affected users instead of widely distributing a survey. Additionally, the data gathering mechanism includes inquiries that are directed to the additional information instead of generalized, potentially irrelevant inquiries. The data collected responsive to the data gathering mechanism may be further analyzed to determine mitigation actions to address the anomaly. Because the AI engine has access to the data received by the managed network, the inquiries are specific to the particular anomaly and only distributed to the relevant users. The data collected from the inquiries are accordingly specifically relevant to the anomaly (e.g., sent from involved users), which improves the diagnosis and the mitigation actions.

These and other embodiments are described with reference to the appended Figures in which like item number indicates like function and structure unless described otherwise. The configurations of the present systems and methods, as generally described and illustrated in the Figures herein, may be arranged and designed in different configurations. Thus, the following detailed description of the Figures, is not intended to limit the scope of the systems and methods, as claimed, but is merely representative of example configurations of the systems and methods.

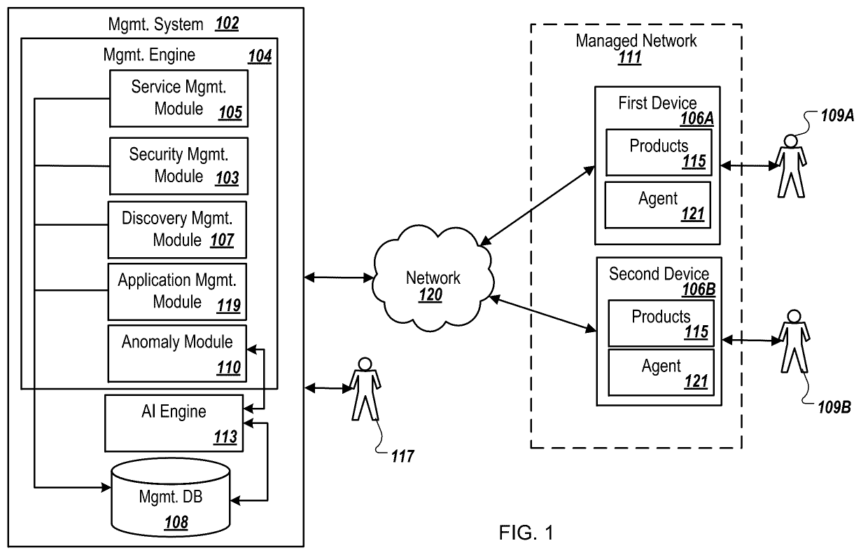

FIG. 1 depicts an example operating environment 100 in which some embodiments may be implemented. The operating environment 100 may include a management system 102 communicatively coupled to one or more devices 106A-106B (generally, device 106 or devices 106) that are included in a managed network 111. The management system 102 may include a management engine 104 that includes an anomaly module 110. The anomaly module 110 is configured to provide anomaly detection and mitigation to the managed network 111. The anomaly module 110 provides a technical improvement to management of the devices 106. For example, the anomaly module 110 is configured to interface with an AI engine 113 to discover anomalies in data received from the devices 106. In some embodiments, the AI engine 113 may include a third-party AI model such as Azure™ ChatGPT, YOLO™, Pytorch™, Tensorflow™, BERT™, ResNet™, and the like. In some embodiments, the AI engine 113 may be trained using data and information related to the managed network 111. Accordingly, the AI engine 113 may have access to information indicative of normal operations of the managed network 111 and functionality available in the managed network 111. Accordingly, the AI engine 113 may leverage the information of the managed network 111 to improve the accuracy of responses and analysis of the AI engine 113. In some embodiments, the AI engine 113 may be “out-of-the-box.”

The anomalies may include patterns of behavior or device states that indicate sub-optimal conditions or sub-optimal operations. The anomalies may be localized in the managed network 111. For instance, the anomalies may affect one of the devices 106 or a small number of the devices 106. Additionally, the anomalies may not be a standard or regular deficiency experienced in the managed network 111.

The anomaly module 110 may be further configured to generate data gathering mechanisms such as surveys, inquiries, or questionnaires. The data gathering mechanisms may be narrowly tailored to obtain additional information from affected portions of the devices 106 and/or affected portions of users 109A or 109B (generally, user 109 or users 109). The anomaly module 110 may analyze data collected by the data gathering mechanism to generate an alteration, which may be implemented in the managed network 111 to mitigate or address the anomaly.

The anomaly module 110 enables detection of anomalies that may go otherwise unidentified. Moreover, the data gathering mechanism focuses on affected portions of the managed network 111 instead of all of the managed network 111 that includes unaffected portions of the managed network 111.

Conventional management services (implemented by management modules 105/103/107/108) may not be configured to address the anomalies and to properly address the anomalies. Moreover, the conventional management systems may not be equipped with functionality needed to identify additional information involved in complete diagnosis of anomalies experienced by conventional managed networks. Accordingly, in conventional management systems, the anomalies go unmitigated.

In the embodiment of FIG. 1, the operating environment 100 may include the devices 106 and the management system 102 that communicate via a network 120. The network 120 is configured to communicate data and information between the devices 106 and the management system 102. These components of the operating environment 100 are introduced in the following paragraphs.

The network 120 may include any communication network configured for communication of signals between the components (e.g., 102 and 106) of the operating environment 100. The network 120 may be wired or wireless. The network 120 may have configurations including a star configuration, a token ring configuration, or another suitable configuration. Furthermore, the network 120 may include a local area network (LAN), a wide area network (WAN) (e.g., the Internet), and/or other interconnected data paths across which multiple devices may communicate. In some embodiments, the network 120 may include a peer-to-peer network. The network 120 may also be coupled to or include portions of a telecommunications network that may enable communication of data in a variety of different communication protocols.

In some embodiments, the network 120 includes or is configured to include a BLUETOOTH® communication network, a Z-Wave® communication network, an Insteon® communication network, an EnOcean® communication network, a Wi-Fi communication network, a ZigBee communication network, a representative state transfer application protocol interface (REST API) communication network, an extensible messaging and presence protocol (XMPP) communication network, a cellular communications network, any similar communication networks, or any combination thereof for sending and receiving data. The data communicated in the network 120 may include data communicated via short messaging service (SMS), multimedia messaging service (MMS), hypertext transfer protocol (HTTP), direct data connection, wireless application protocol (WAP), or any other protocol that may be implemented in the components of the operating environment 100.

The managed network 111 is implemented to enable management of the devices 106 by the management system 102. To implement the managed network 111, the devices 106 may be enrolled. After the devices 106 are enrolled, ongoing management of the devices 106 may be implemented by the management system 102. The ongoing management may include overseeing and dictating at least a part of the operations at the devices 106 as described in the present disclosure. For instance, the ongoing management may enable anomaly detection and mitigation.

The devices 106 may include hardware-based computer systems that are configured to communicate with the other components of the operating environment 100 via the network 120. The devices 106 may include any computer device that may be managed by the management system 102 and/or have been enrolled in a managed network 111. Generally, the devices 106 include computing devices that are operated by the users 109 and systems of an enterprise associated with the managed network 111. The devices 106 might include workstations of an enterprise, servers, data storage systems, printers, telephones, internet of things (IOT) devices, smart watches, sensors, automobiles, battery charging devices, scanner devices, etc. The devices 106 may also include virtual machines, which may include a portion of a single processing unit or one or more portions of multiple processing units, which may be included in multiple machines.

The devices 106 include the products 115. The products 115 may include applications, components, systems, drivers, of any kind or type. Some examples of the products 115 may include software applications, enterprise software, operating systems, hardware components, installed printers, memory locations, utilized monitors, ports, plug-ins, services, network communication components, the device 106 itself (or information related thereto), similar computer-related features or components, or combinations thereof. The products 115 may differ between the devices 106. For instance, the first device 106A might have a processor with a different capacity than the processor of the second device 106B.

The devices 106 might also include an agent 121. In some embodiments, the management engine 104 may interface with the agent 121. For instance, the agent 121 may have a high level of privilege on the device 106, which enables visibility of the agent 121 to the products 115 as well as operational parameters related to or characterizing the products 115. The agent 121 may be configured to exist on the devices 106 to support ongoing management of the devices 106. The agent 121 may interface with local applications (e.g., the search feature) on the devices 106 and may support communication of information with the management system 102. In some embodiments, the management engine 104 may be configured to interface directly with the agent 121.

In some embodiments, at least some of the devices 106 may not include the agent 121. In these and other embodiments, the management engine 104 might interface indirectly with the devices 106. For instance, interactions may be between the management engine 104 and another, non-affected device 106 and mitigation may be performed on an affected device 106.

The devices 106 may be associated with the users 109. The phrase “associated with” when describing the relationship between the devices 106 and the users 109 indicates that the users 109 generally or regularly operate the devices 106. Because of this association, references in the present disclosure to communication of a message or inquiry to the user 109 may indicate that the inquiry is communicated to the device 106 associated with the user 109. Similarly, a response by one of the users 109 may indicate that the user 109 provided user input to the device 106, which is communicated to the management system 102.

The management system 102 may include a hardware-based computer system that is configured to communicate with the other components of the operating environment 100 via the network 120. In some embodiments, the management system 102 may be a single server, a set of servers, a virtual device, or a virtual server in a cloud-base network of servers. In these and other embodiments, one or more of the components of the management system 102 (e.g., service management modules 105/103/107/119 and the anomaly module 110) may be spread over two or more cores, which may be virtualized across multiple physical machines.

The management system 102 may be associated with an administrator 117. The administrator 117 may be an individual, a set of individuals, or a system that interfaces with the management system 102. In some embodiments, the administrator 117 may provide input to the management system 102. The input provided by the administrator 117 may form the basis of some computing processes and operations performed by the management system 102.

As stated above, the management system 102 operates with the managed network 111 to provide management operations or management services to the devices 106. To provide the management services, the management system 102 includes the management engine 104 that is configured to perform one or more management operations relative to the devices 106. The management engine 104 may include one or more service management modules 105/103/107/119 that may each be dedicated to a particular management service. The management engine 104 may implement one or more combinations of the service management modules 105/103/107/119 to the devices 106. The service management modules 105/103/107/119 of the embodiment of FIG. 1 are described in the following paragraphs. Additional management services or derivative management services may be implemented in other embodiments.

The management engine 104 includes a service management module 105, a security management module 103, a discovery management module 107, an application management module 119, and the anomaly module 110. The service management module 105 may be configured to implement technical support such as help desk and ticketing services. The security management module 103 may maintain the security of the devices 106 such as virus and vulnerability management. The discovery management module 107 may identify the devices 106, implement role-based access management, and identify parameters of the devices 106. The application management module 119 may maintain the products 115 and ensure the user 109 has access to the products 115.

Associated with these management operations are data that represent attributes of the devices 106 in substantially real time (e.g., with material delay) or real time. The attributes might include operating parameters of the devices 106, network parameters of the managed network 111, acute event parameters, parameters of the products 115, other parameters indicative of the operations of the devices 106, and the like.

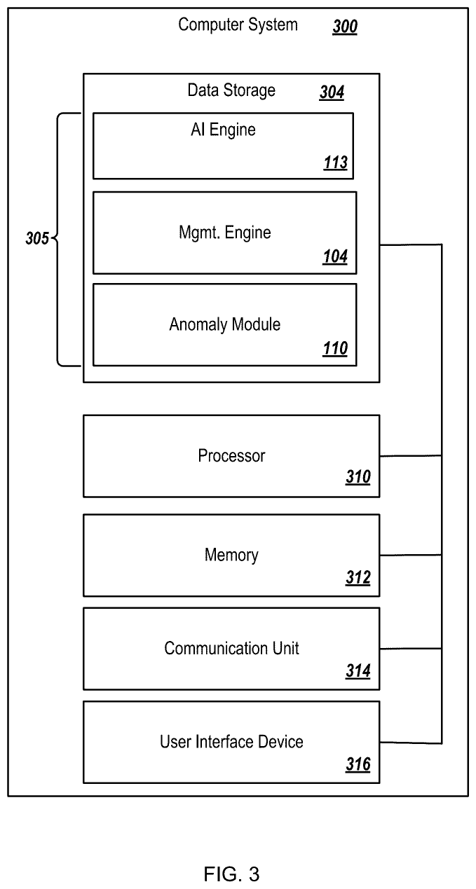

The service management modules 105/103/107/119 may communicate the data to a management database 108 (in the Figures, “Mgmt. DB”). The management database 108 may include a non-transitory data storage device such as memory 312 of FIG. 3. The management database 108 may have stored thereon data and information related to the devices 106; the users 109; the network 120; the managed network 111; the products 115; normal and abnormal operation of the devices 106, the network 120, the managed network 111, the products 115; and normal and abnormal interactions between the users 109 and the devices 106.

The management system 102 may include the AI engine 113. The AI engine 113 may access the information in the management database 108. The AI engine 113 may be used by the anomaly module 110 to discover and mitigate anomalies in the managed network 111. The AI engine 113 may further leverage data and information related to the managed network 111 or an entity that is associated with the managed network 111 and/or the management system 102. For instance, the management system 102 may publish technical resources regarding the management engine 104, which may provide information related to normal or proper operation of the devices 106 and the managed network 111. The AI engine 113 may use the data in the management database 108 as a basis of its training and to direct output. The AI engine 113 may determine patterns of normal operation of the managed network 111 and to further identify patterns of anomalous (e.g., abnormal) patterns in the data. The AI engine 113 may identify the patterns in substantially real time or with a minimal delay because the data in the management database 108 is received in real time or substantially real time from the devices 106.

In the embodiment of FIG. 1 and other embodiments, the AI engine 113 is included in the management system 102. In some embodiments, the AI engine 113 may be located remotely and have access to the management database 108 and the management engine 104.

The anomaly module 110 may be configured to utilize the AI engine 113 to discover an anomaly in the data. The anomaly is indicative of an event experienced at a portion of the managed network 111. In some circumstances, the event can be mitigated by one of the service management modules 105/103/107/119. For instance, the event relates to a change to the network 120 that the administrator 117 can address through an adjustment to a network connection or a change to a setting at the devices 106. In these and other circumstances, the management engine 104 may simply implement an alteration necessary to address the anomaly.

In other circumstances, the data available in the management database 108 is insufficient to determine the cause of the anomaly and/or define a precise alteration that addresses the anomaly. In these circumstances, in which the data is unavailable, the anomaly module 110 may analyze the anomaly and data related to the anomaly. The data related to the anomaly is available in the management database 108. The data related to the anomaly may include data associated with the identified patterns, which may identify affected portions of the users 109, devices 106, managed network 111, and provide context to the anomaly.

The analysis of the anomaly and the data related to the anomaly may be implemented to determine additional information. The anomaly module 110 may identify the additional information that enables a cause for the anomaly to be established and/or enables an alteration to the devices 106, the managed network 111, the network 120, or some combination thereof that mitigates the anomaly. The additional information includes a fact, a detail, a figure, a number, an opinion, a preference, etc. that are relevant to the anomaly and that are not present in the management database 108. For instance, the anomaly may include a decrease in production following a change to one of the products 115 at the first device 106. The additional information may include feedback from the first user 109A regarding the change.

The anomaly module 110 may generate a data gathering mechanism (hereinafter, “mechanism”) to collect the additional information. In some embodiments, the anomaly module 110 may generate the mechanism based on the AI engine 113 and/or prior analysis of the anomaly. Some examples of the mechanism may include a survey, an inquiry, a questionnaire, and the like. The mechanism may include at least a portion of the data related to the anomaly and the substance of the mechanism may be directed to the additional information. For instance, the data related to the anomaly may include affected users 109, affected devices 106, affected products 115, affected portions of the managed network 111, and the like. In addition, the data related to the anomaly might include a particular setting, a parameter of a system, historical event or set of events, parameters or settings of the devices 106, etc. that relates to the anomaly. The data related to the anomaly provides the context of the mechanism and may clarify the additional information requested by the mechanism. Accordingly, the mechanism is narrowly tailored to the particular anomaly. The mechanism may be focused on the affected user 109 or users 109 instead of all users of the managed network 111 and may include a few (one, two, or three) questions.

The mechanism provides an improvement to conventional systems. In particular, without the mechanisms, many anomalies may go unresolved. For instance, the management engine 104 may have insufficient information to determine a cause or a solution to the anomaly. Thus, the anomaly may remain unresolved. Alternatively, without the mechanism and the anomaly module 110, the administrator 117 may perform manual evaluation of anomalies (e.g., responsive to a ticket submitted by the user 109). The administrator 117 does not have the benefit of the AI engine 113, which limits a wholistic view of operations of the managed network 111. Accordingly, the anomaly may be inaccurately assessed. Alternatively still, without the specificity of the mechanism, the management system 102 may generate and distribute a broad or poorly targeted survey to collect information. Such distribution negatively affects the managed network 111. Specifically, the users 109 answer surveys or submit information for anomalies that do not affect them. The results are skewed by willingness to participate in the data collection rather than impact of the anomaly. The skew may result in inaccurate assessment and mitigation of the anomaly as well as potentially obscuring the anomaly entirely.

In contrast, the anomaly module 110 of FIG. 1, generates a targeted, specific mechanism. In some embodiments, only those affected by the anomaly are scheduled for distribution and the mechanism is directed to the specific anomaly instead of a broad range of inquiries.

In some embodiments, the mechanism may be submitted for review. For instance, the anomaly module 110 may communicate the mechanism or a proposed form thereof to the administrator 117 or to another suitable review operation. The administrator 117 or the review operation may evaluate the mechanism prior to its distribution.

The anomaly module 110 may distribute the mechanism. For instance, the anomaly module 110 may communicate the mechanism to the devices 106 via the network 120. For instance, the mechanism may include a survey, which is communicated to the first device 106A via email or via a messaging application included in one of the products 115 of the first device 106A. As another example, the data gathering mechanism may include a retrieval operation for a particular data set the first device 106A.

After the mechanism is received by one or more of the devices 106, data representative of the additional information may be input. For instance, the first user 109A of the first device 106A may provide input into the survey. Data collected from using the distributed mechanism (hereinafter, “collected data”) may be communicated to the anomaly module 110 via the network 120. The anomaly module 110 may then analyze the collected data relative to the anomaly and data related to the anomaly. For example, in some embodiments the anomaly module 110 may determine a cause of the anomaly and determine an alteration to the managed network 111 to resolve the anomaly. In some embodiments, the anomaly module 110 may otherwise process the collected data. The collected data may then be entered into the management database 108 such that it is available to the management engine 104 and/or the administrator 117. The collected data may inform another process, application, or workflow.

In instances in which the alteration is determined, the anomaly module 110 or another portion of the management engine 104 may implement the alteration. For instance, the management engine 104 may communicate a control signal to an affected portion of the devices 106 to modify the state of a setting at the device 106 such that the anomaly is mitigated.

The management engine 104, the AI engine 113, at least some of the products 115, the agent, combinations thereof, and components thereof may be implemented using hardware including a processor, a microprocessor (e.g., to perform or control performance of one or more operations), a field-programmable gate array (FPGA), or an application-specific integrated circuit (ASIC). In some other instances, management engine 104, the AI engine 113, at least some of the products 115, the agent, combinations thereof, and components thereof may be implemented using a combination of hardware and software. Implementation in software may include rapid activation and deactivation of one or more transistors or transistor elements such as may be included in hardware of a computing system (e.g., the devices 106 or the management system 102 of FIG. 1). Additionally, software defined instructions may operate on information within transistor elements. Implementation of software instructions may at least temporarily reconfigure electronic pathways and transform computing hardware.

Modifications, additions, or omissions may be made to the operating environment 100 without departing from the scope of the present disclosure. For example, the operating environment 100 may include one or more managed networks 111, one or more management systems 102, one or more devices 106, one or more networks 120 or any combination thereof. Moreover, the separation of various components and devices in the embodiments described herein is not meant to indicate that the separation occurs in all embodiments. Moreover, it may be understood with the benefit of this disclosure that the described components and servers may be integrated together in a single component or server or separated into multiple components or servers.

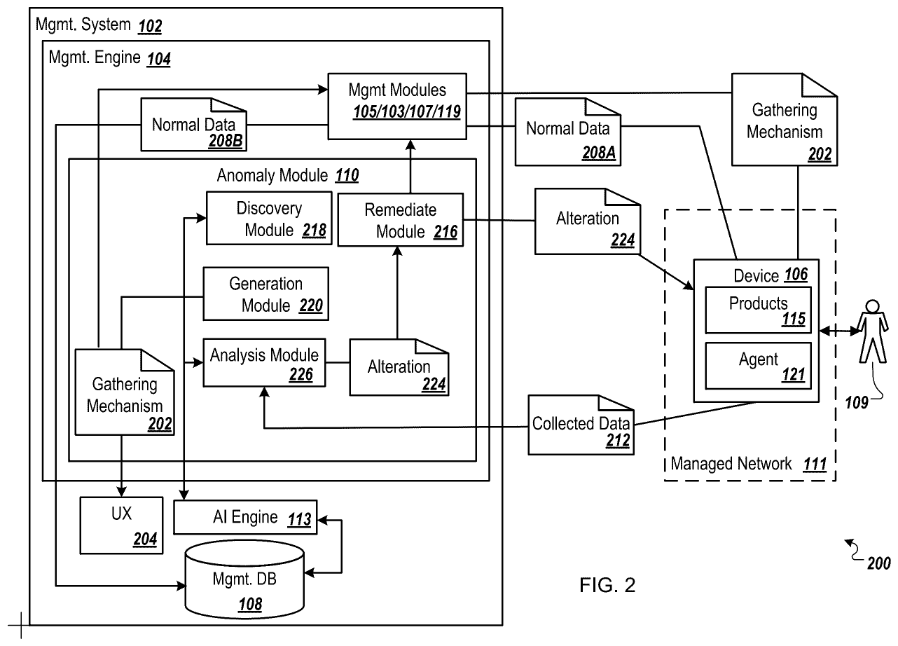

FIG. 2 is a block diagram of an example process 200 of AI-based system anomaly diagnosis and remediation that may be implemented in the operating environment 100 of FIG. 1 or another suitable environment. The process 200 of FIG. 2 includes some components (e.g., 102, 104, 106, 111, 113, 115, 109, etc.) described with reference to FIG. 1. Although not depicted in FIG. 2, communications in the process 200 may be via a network such as the network 120.

In FIG. 2, the process 200 is implemented in the management system 102 in which data that is indicative of operations of the device 106 is harvested and used by the management modules 105/103/107/119. This data is referred to in FIG. 2 as “normal data” 208A and 208B and generally in the present disclosure as normal data 208. The normal data 208 is indicative of device function and user interaction with the managed device 106. The normal data 208 is used by the management modules 105/103/107/119 to perform management services in the managed network 111. Additionally, the normal data 208 may enable generation of derivative metrics such as a digital experience index. The normal data 208 includes a variety of information related to the device 106, which may be based on the particular types of management services and corresponding management modules 105/103/107/119 implemented in the management engine 104. For instance, the management modules 105/103/107/119 in the depicted embodiment includes the service management module 105, the security management module 103, the discovery management module 107, and the application management module 119. Each of the management modules 105/103/107/119 may pull portions of the normal data 208 that are used in the corresponding management service provided to the managed network 111.

For instance, the service management module 105 may receive data and information related to help desk and service management functions such as data representative of an incident report, a description and subject of an incident report or ticket, a priority or urgency of an incident report, a mean time to resolve (MTTR), a current status of an incident, a first call resolution, an escalation of an incident, an inquiry or inquiry response, other service management metrics, or combinations thereof. The security management module 103 may receive data and information related to security management such as data representative of an antivirus status, a firewall status, a spyware status, data protection indicators, a password strength, a patch status, a user access control status, a risk-based vulnerability assessment, presence of vulnerabilities, outstanding patch assessment, other security metrics and parameters, or combinations thereof. The discovery management module 107 may receive data and information related to discovery and device status of the device 106 such as data representative of device age, battery status, central processing unit (CPU) usage, memory usage, storage usage, an operating system (OS) update, jurisdictional assignments of users 109, human resource (HR) changes to roles and assignments, an OS install date, a boot degradation, a user profile or a portion of the user profile, a system failure indication, a blue screen error notification, other discovery and device parameters, or combinations thereof. The application management module 119 may receive data related to management of the products 115 or portions thereof on the device 106 such as data representative of an application error, a license status of an application, cloud service usage, cloud service outage, service mapping, application telemetry, application usage indicative of user frustration, an application log, a digital signature of an application, an application scan, survey bot inquiries and responses, information from bots scheduled to logon to application, other parameters related to the products 115, or combinations thereof.

The portion of the normal data 208 received by the management modules 105/103/107/108 is represented in FIG. 2 by normal data 208A. The normal data 208A is processed by the management modules 105/103/107/119 to provide a management function in the managed network 111 such as addressing a ticket, updating one of the products, onboarding the user 109 on the device 106, etc.

The normal data 208 or some derivative of the normal data 208 may be communicated to the management database 108. In FIG. 2, the normal data 208 that is communicated to the management database 108 is represented by normal data 208B. The normal data 208B may include data related to rendering management services by the management modules 105/103/107/119. In addition, the normal data 208B communicated to the management database 108 may include information related to a rendered management service such as data related to remediation processes, communications during a ticket trouble-shooting discussion, etc.

The AI engine 113 may access the management database 108. The AI engine 113 may be utilized by a discovery module 218 to discover and identify anomalies in the normal data 208. For instance, the discovery module 218 may be configured to provide input and prompts to the AI engine 113 to identify patterns that are indicative of the anomaly.

The anomaly discovered by the AI engine 113 and the discovery module 218 is indicative of an event experienced at a portion of the managed network 111. The anomaly is based on one or more patterns recognized in the normal data 208 that is indicative of a sub-optimal operation at the device 106. The anomaly may differ from conventional management service issues addressed by the management modules 105/103/107/119. For instance, the anomaly generally relates to an individual user (e.g., 109) or a few users (e.g., fewer than ten or twenty) of the users 109. The anomaly is also discovered at a high level of granularity. For instance, the anomaly may be related to a distinct activity or a distinct hardware issue of the device 106.

The discovery of the anomaly in the normal data 208 may be based on identification of one or more patterns in the normal data 208. For instance, the discovering may include identifying a pattern of operations in the device 106, identifying a pattern of operations in one of the products 115 that is running on the devices 106, identifying a pattern of interoperability data related to a product update, identifying a pattern in an HR workflow, identifying other patterns that are anomalous, or combinations thereof. Additionally, in some embodiments, the anomaly is indicative of a malfunctioning device or a suboptimal interaction by the user 109 with the device 106, the managed network 111, or between an entity associated with the managed network 111 and the user 109. For instance, the anomaly may include non-use of a licensed software, a first or an early user of a new hardware or software, a modification of a role of the user 109 in the managed network 111, a new staff member, a change in location of the user 109, a repeated computing operation (e.g., disabling of a firewall), a repeated malfunction of the device 106 such as a periodic and repetitive low battery warning, etc.

In some embodiments, the anomaly is discovered prior to submission of a ticket in the service management module 105. For instance, the AI engine 113 may perform the discovery operation as an ongoing monitoring operation during which the anomaly is discovered. Accordingly, the anomaly is discovered and may be resolved independently of the service management module 105 without or with minimal interaction by the user 109 and without the user 109 initiating the resolution via the service management module 105.

The anomaly is communicated to an analysis module 226. The analysis module 226 may analyze the anomaly and portions of the normal data 208 related to the anomaly. The anomaly and the data related to the anomaly may be analyzed using the AI engine 113 in some embodiments. The anomaly and the data related to the anomaly may be analyzed to determine additional information relevant to the anomaly that is not present in the normal data 208. In some embodiments, the AI engine 113 is trained on the normal data 208 of the managed network 111 such as data indicative of normal operation of the device 106. Accordingly, the pattern indicative of the anomaly may be compared to optimal operations and/or optimal behavior of the device 106.

In some embodiments, determination of the additional information may include determining multiple different underlying issues that are potential causes of the anomaly. For instance, a functional issue experienced at one of the devices 106 may have two or more causes. There may be some information that narrows the potential causes down to a single cause. Accordingly, in these and other embodiments, the additional information includes data used to identify which of the multiple different underlying issues is the actual underlying issue that is the cause of the anomaly.

The generation module 220 may be configured to generate a data gathering mechanism 202 (as above, the data gathering mechanism is referred to as “mechanism”). The mechanism 202 may be generated to collect the additional information. The mechanism 202 may be generated based on the AI engine 113. In some embodiments, the mechanism 202 includes an identification of one or more users (e.g., 109) and/or one or more of the devices (e.g., 106) that are directly affected by the anomaly. Additionally, the mechanism 202 may include at least one request directed to the additional information. Additionally or alternatively, in some embodiments, the mechanism 202 may include a survey directed to the user 109 who is associated with the anomaly and one or more questions in the survey that are directed to collection of the additional information. Identification of affected users and/or affected managed devices may result in an improved outcome. For instance, instead of communication of the survey to all or substantially all users (e.g., the user 109) or managed device (e.g., device 106), the mechanism 202 may be communicated to only those affected by the anomaly.

In some embodiments, the mechanism 202 may be submitted for review prior to submission. For instance, in the process 200, the mechanism 202 may be communicated to a user interface (UX) 204. Display of the mechanism 202 may be caused in the UX 204 such that the administrator 117 is able to review it. The administrator 117 may approve the mechanism 202. The administrator 117 may communicate input to the management engine 104 that indicates approval. In these and other embodiments, approval may trigger distribution of the mechanism 202.

In some embodiments, the mechanism 202 may not be submitted for review. Additionally, in the embodiment of FIG. 2, the UX 204 is depicted as part of the management system 102. In other embodiments, the UX 204 may be included in another device such as one of the managed devices 106 that is associated with the administrator 117.

One or more of the management modules 105/103/107/119 may be configured to distribute the mechanism 202. For example, in embodiments in which the mechanism 202 includes a survey, the survey may be emailed to the user 109 or may be sent in a Microsoft TEAMS™ message to the identified managed device 106. The mechanism 202 is communicated to an affected user (e.g., 109) or an effected device (e.g., 106) instead of all users of the managed network 111 or all devices 106 of the managed network 111. Accordingly, in the process 200, the distribution of the mechanism 202 is targeted to affected devices 106 and/or affected users 109, which may improve response and relevance of the collected data 212.

The user 109 may respond to the mechanism 202. For instance, the mechanism 202 may include an electronic survey, which may be displayed on the device 106. For instance, the device 106 may include a UX (similar to UX 204) and one of the products 115 may include a messaging application such as Microsoft TEAMS. The mechanism 202 may include one or more screens that include questions that are communicated to the messaging application and displayed on the UX of the device 106. The user 109 may respond to the survey by entering information into fields or blocks of the screens, selecting multiple choice options in the screens, or another suitable data input operation.

The information entered into the mechanism 202 may be communicated as collected data 212 to the management engine 104. The analysis module 226 may be configured to receive the collected data 212 from the device 106. For instance, in embodiments in which the mechanism 202 includes a survey, the recipient may answer questions in the survey, which are then communicated as the collected data 212.

The analysis module 226 may determine an alteration 224. The alteration 224 may be determined based on the collected data 212 as well as the data related to the anomaly of the management database 108. For instance, the analysis module 226 may use the AI engine 113 to analyze the collected data 212 with the data available in the management database 108. Accordingly, the analysis of the collected data 212 evaluates the anomaly, with the collected data 212, which corresponds to or provides insight into the additional information. Thus, the evaluation conducted with the collected data 212 may include an initial set of data (used to generate the mechanism 202) along with the additional information, which was deemed necessary to address the anomaly. In some instances, the anomaly module 110 performs an initial analysis of the anomaly to determine the alteration 224. During the initial analysis, it is determined that additional information may be informative or necessary to determine the alteration 224. The collected data 212 at least partially provides the additional information. The analysis module 226 then reevaluates the anomaly with the additional information to determine the alteration 224. In some embodiments in which multiple underlying issues may cause the anomaly, as part of determination of the alteration 224, the actual underlying issue may be identified. The alteration may be determined to address the actual underlying issue.

In some embodiments, the analysis module 226 may be configured to process at least a portion of the collected data 212. The analysis module 226 may process the collected data 212 to configure the collected data 212 such that the AI engine 113 is able automatically analyze the collected data 212. For instance, the analysis module 226 may be configured to receive the collected data 212. Prior to communicating the collected data 212 to the AI engine 113, the analysis module 226 may calculate a parameter derived from the collected data 212. An example may be the mechanism 202 requesting a net promoter score (e.g., on a scale of 0 to 10 what is the likelihood a user would recommend a first application). The analysis module 226 may receive the collected data 212 and implement one or more operations to calculate the net promoter score prior to communicating the collected data 212 to the AI engine 113. Calculation of the net promoter score prior to communication to the AI engine 113 may better utilize the functionality of the AI engine 113 and avoid limitations of the AI engine 113.

In some embodiments, the alteration 224 may be directed to the managed network 111 or a portion thereof to resolve the anomaly. In these and other embodiments, the alteration 224 may be communicated to a remediate module 216. The remediate module 216 is configured to implement the alteration 224. The remediate module 216 may communicate the alteration 224 to the device 106 or to the management modules 105/103/107/119 to implement the alteration 224. For instance, the alteration 224 may include a control signal or command. The alteration 224 may be communicated to the device 106 (or agent 121 thereon) to cause a change to a state of the device 106 (e.g., pushing a patch to the managed endpoint, enabling a firewall, changing power settings, deleting a log file, removing or updating a software application, etc.).

Additionally or alternative, the alteration 224 may include implementing a hardware change. For instance, the alteration 224 may include generating and issuing a request for an additional piece of hardware or hardware component (e.g., issuing a request for a new battery, a different computing device, an additional monitor, etc.). In these and other embodiments, the alteration 224 may be communicated to one of the management modules 105/103/107/119 to trigger a process to order and deliver the hardware component. Additionally or alternatively, the alteration 224 may include initiating, supplementing, or progressing an automated HR workflow in one of the management modules 105/103/107/119. For instance, the survey may include an exit survey when the user 109 is no longer involved in the managed network 111. The collected data 212 may be incorporated in an HR workflow that relies on the collected data 212. Based on the collected data 212, the HR workflow may progress and may be at least partially form the basis of a report.

Some non-limiting examples of the process 200 are provided in the following paragraphs. Although ten example anomalies are described, these are provided as examples only and are not limiting.

A first example anomaly may include detection of the user 109 repeatedly disabling a firewall. The cause of the anomaly may include an authorized action by the user or may be a security threat actor that is otherwise not detectable. The additional information may include whether the user 109 has disabled the firewall and if so, why? The mechanism 202 may include an inquiry communicated to the device 106 with the questions. The collected data 212 may include an answer “no.” The alteration 224 may include mitigation directed to the security threat that is disabling the firewall.

A second example anomaly may include the device 106 repeated overheating. The causes of the device 106 overheating may be a hardware issue (e.g., failing fan or aging thermal connection of CPU) or may be a change in a work environment. The additional information may include whether the work environment has changed recently. The mechanism 202 may include a survey directed to the user 109 to determine whether their work environment has changed. The collected data 212 may include an answer “no.” The alteration 224 may include initiation of a device replacement for the user 109.

A third example anomaly may include a repeated, frequent low battery warning. The causes may include a failing battery or an inefficient power setting at the device 106. The additional information may include a computing inquiry that pulls the power settings and history of battery settings of the device 106 as well as the age of the battery of the device 106. The collected data 212 may include the age information indicating that the battery is within its operable life and power setting information indicating that the power setting is high. The alteration 224 may include a command communicated to the device 106 to change the power setting and a notification to the user 109 of the change.

A fourth example anomaly may include a low disk space warning. The causes may include user activity resulting in large files being saved to the device 106 or may include a security threat that is generating a logging file. The additional information may include whether the user 109 has recently stored large files or been involved in a process that results in large files being generated and stored on the device 106. The mechanism 202 may include an inquiry communicated to the device 106 with the questions. The collected data 212 may include an answer “no.” The alteration 224 may include initiation of a mitigation for a vulnerability that is generating the log file.

A fifth example anomaly may include inefficient work behavior such as the user 109 switching applications multiple times during working periods. The additional information may include whether the user 109 has access to a second monitor. The mechanism 202 may include a questionnaire distributed to the user 109 about whether their work environment can support a second monitor, preferences, etc. The collected data 212 may include a request for a particular monitor. The alteration 224 may include triggering a work order to obtain the selected monitor for the user 109.

A sixth example anomaly may include high printing usage by the user 109. The causes may include inefficient work operations or a particular project that requires the print usage. The additional information may include whether there is a project undertaken by the user 109 that requires the usage. The mechanism 202 may include a questionnaire with questions on the projects and its print requirements. The collected data 212 may include an indication that no particular project requires the printer usage. The alteration 224 may include communicating a computer-based editing software to the user 109 along with scheduling training for the user to use the software.

A seventh example anomaly may include the user 109 frequently rebooting the device 106 or repeatedly re-installing a particular application. The cause may include the user 109 troubleshooting the device 106 or the application or may be a misunderstanding of the user 109 into a function or operation of the device 106 or the application. The mechanism 202 may include whether the user 109 is experiencing a technical issue with the device 106 or the application. The mechanism 202 may include a question regarding the function of the device 106 or the application. The collected data 212 may include a history of problems with the application that causes the device 106 to lock, requiring the reboot. The alteration 224 may include removing the application, installing a newer version that does not have the technical issue.

An eighth example anomaly may include the user 109 being reassigned to another office, being newly hired, or changing departments. There is not a cause of the eighth anomaly. Instead, the additional information may relate to the experience of the user 109. The mechanism 202 may include a directed survey that asks about the experience of the user 109 following the change. The collected data 212 may be the answers to the survey. The alteration 224 may correspond to the collected data 212. For instance, if the collected data 212 indicates they cannot get the printer to work, the alteration 224 may program the device 106 with the printer driver, etc. In addition, the collected data 212 may be communicated to an HR team for inclusion in a workflow related to other HR issues.

A ninth anomaly may include the user 109 being a first user of a new hardware or a new software, which may be one of the products 115. The additional information may include feedback regarding the change. The mechanism 202 may include a survey that asks about the quality and function of the new hardware or the new software. The collected data 212 may include opinions of the user 109 regarding the new hardware or the new software. The alteration 224 may correspond to the collected data 212. For instance, if the collected data 212 indicates the new hardware or the new application does not meet the need of the user 109, the alteration 224 may include changes to the device 106 to better operate with the new hardware or a removal of the new application.

A tenth anomaly may include non-use of one of the products 115 by the user 109 on the device 106. The additional information may include whether the user 109 has found a substitute or has changed roles such that the product 115 is no longer needed. The mechanism 202 may ask whether the user 109 needs or would like to retain the unused product 115. The collected data 212 may include an answer “no.” The alteration 224 may include removal of the unused product 115 and a license reclamation process initiation.

FIG. 3 illustrates an example computing system 300 configured for anomaly discovery and mitigation according to at least one embodiment of the present disclosure. The computing system 300 may be implemented in the operating environment 100 of FIG. 1 or another suitable operating environment. Examples of the computing system 300 may include the management system 102, the devices 106, or some combination thereof. The computing system 300 may include one or more processors 310, a memory 312, a communication unit 314, a user interface device 316, and a data storage 304 that includes the management engine 104, the anomaly module 110, and the AI engine 113 (collectively, modules 305).

The processor 310 may include any suitable special-purpose or general-purpose computer, computing entity, or processing device including various computer hardware or software modules and may be configured to execute instructions stored on any applicable computer-readable storage media. For example, the processor 310 may include a microprocessor, a microcontroller, a digital signal processor (DSP), an ASIC, an FPGA, or any other digital or analog circuitry configured to interpret and/or to execute program instructions and/or to process data. Although illustrated as a single processor in FIG. 3, the processor 310 may more generally include any number of processors configured to perform individually or collectively any number of operations described in the present disclosure. Additionally, one or more of the processors 310 may be present on one or more different electronic devices or computing systems. In some embodiments, the processor 310 may interpret and/or execute program instructions and/or process data stored in the memory 312, the data storage 304, or the memory 312 and the data storage 304. In some embodiments, the processor 310 may fetch program instructions from the data storage 304 and load the program instructions in the memory 312. After the program instructions are loaded into the memory 312, the processor 310 may execute the program instructions.

The memory 312 and the data storage 304 may include computer-readable storage media for carrying or having computer-executable instructions or data structures stored thereon. Such computer-readable storage media may include any available media that may be accessed by a general-purpose or special-purpose computer, such as the processor 310. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may also be included within the scope of computer-readable storage media. Computer-executable instructions may include, for example, instructions and data configured to cause the processor 310 to perform a certain operation or group of operations.

The communication unit 314 may include one or more pieces of hardware configured to receive and send communications. In some embodiments, the communication unit 314 may include one or more of an antenna, a wired port, and modulation/demodulation hardware, among other communication hardware devices. In particular, the communication unit 314 may be configured to receive a communication from outside the computing system 300 and to present the communication to the processor 310 or to send a communication from the processor 310 to another device or network (e.g., the network 120 of FIG. 1).

The user interface device 316 may include one or more pieces of hardware configured to receive input from and/or provide output to a user. In some embodiments, the user interface device 316 may include one or more of a speaker, a microphone, a display, a keyboard, a touch screen, or a holographic projection, among other hardware devices.

The modules 305 may include program instructions stored in the data storage 304. The processor 310 may be configured to load the modules 305 into the memory 312 and execute the modules 305. Alternatively, the processor 310 may execute the modules 305 line-by-line from the data storage 304 without loading them into the memory 312. When executing the modules 305, the processor 310 may be configured to perform one or more processes or operations described elsewhere in this disclosure.

Modifications, additions, or omissions may be made to the computing system 300 without departing from the scope of the present disclosure. For example, in some embodiments, the computing system 300 may not include the user interface device 316. In some embodiments, the different components of the computing system 300 may be physically separate and may be communicatively coupled via any suitable mechanism. For example, the data storage 304 may be part of a storage device that is separate from a device, which includes the processor 310, the memory 312, and the communication unit 314, that is communicatively coupled to the storage device. The embodiments described herein may include the use of a special-purpose or general-purpose computer including various computer hardware or software modules, as discussed in greater detail below.

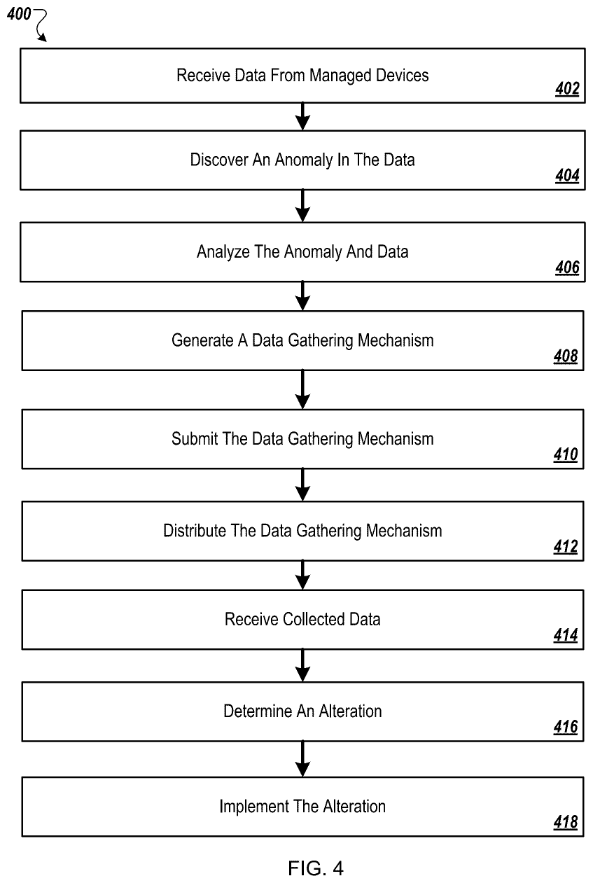

FIG. 4 is a flow chart of an example method 400 of AI-based anomaly diagnosis and remediation that may be implemented in the operating environment 100 of FIG. 1 or another suitable environment. The method 400 may begin at block 402 in which data may be received. The data may be received from managed devices in a managed network. For instance, the data may be indicative of device function and user interaction with managed devices. At block 404, an anomaly may be discovered. The anomaly may be discovered in the data received from the managed devices. The anomaly is indicative of an event experienced at a portion of the managed network.

In some embodiments, the discovery of the anomaly in the data may be based on identification of one or more patterns in the data. For instance, the discovering may include identifying a pattern of operations in one or more of the managed devices, identifying a pattern of operations in a software that is running on one or more of the managed devices, identifying a pattern of interoperability data related to a product update, identifying a pattern in an HR workflow, identifying other patterns that are anomalous, or combinations thereof. Additionally, in some embodiments, the anomaly is indicative of a malfunctioning device or a suboptimal interaction by a user with one of the managed devices, the managed network, or between an entity associated with the managed network and a user. For instance, the anomaly may include non-use of a licensed software, a first or an early user of a new hardware or software, a role modification of a user in the managed network, a new staff member, a change in location of a user, a repeated computing operation (e.g., disabling of a firewall), a repeated malfunction of a device such as a periodic and repetitive low battery warning, etc.

In some embodiments, the anomaly is discovered prior to submission of a ticket in a service management system. For instance, a system implementing the method 400 may perform ongoing monitoring operations during which the anomaly is discovered. Accordingly, the anomaly is discovered and resolved independently of the service management system without or with minimal interaction by the user and without the user initiating the resolution via the service management system.

At block 406, the anomaly and data related to the anomaly may be analyzed. The anomaly and the data related to the anomaly may be analyzed using an AI engine. The anomaly and the data related to the anomaly may be analyzed to determine additional information relevant to the anomaly that is not present in the received data. In some embodiments, the AI engine is trained on data of the managed network such as data indicative of normal operation of the managed devices, optimal interaction of users relative to the managed devices, and optimal behavior of the managed devices.

In some embodiments, determination of the additional information may include determining multiple different underlying issues that are a potential cause of the anomaly based on the analysis of the anomaly and data related to the anomaly. For instance, a functional issue being experienced at one of the managed devices may have two or more causes. There may be some information that narrows the cause down to a single cause. Accordingly, in these and other embodiments, the additional information includes data used to identify which of the multiple different underlying issues is the actual underlying issue that is the cause of the anomaly.

At block 408, a data gathering mechanism may be generated. The data gathering mechanism may be generated to collect the additional information. The data gathering mechanism may be generated based on the AI engine.

In some embodiments, the data gathering mechanism includes an identification of one or more users or one or more of the managed devices that are directly affected by the anomaly and an identification of at least one request direct to the additional information. Additionally or alternatively, in some embodiments, the data gathering mechanism may include a survey directed to one or more users who are associated with the anomaly and one or more questions in the survey that are directed to collection of the additional information. Identification of affected users and/or affected managed devices may result in an improved outcome. For instance, instead of communication of the survey to all or substantially all users or managed devices, the data gathering mechanism may be communicated to only those affected by the anomaly.

At block 410, the data gathering mechanism may be submitted. The data gathering mechanism may be submitted for approval or for review. For instance, the data gathering mechanism may be submitted to an administrator. In some embodiments, the data gathering mechanism may not be submitted. In these and other embodiments, operations of block 410 may not occur.

At block 412, the data gathering mechanism may be distributed. For example, in embodiments in which the data gathering mechanism includes a survey, the survey may be emailed to identified users or may be sent in a TEAMS™ message to one or more identified managed devices. In some embodiments in which the data gathering mechanism is submitted, the distributing the data gathering mechanism may be performed responsive to an indication of an approval received from the administrator.

At block 414, collected data may be received. The collected data may be received responsive to the distributed data gathering mechanism. For instance, in embodiments in which the data gathering mechanism includes a survey, the recipient may answer questions in the survey, which are then communicated as the collected data.

At block 416, an alteration may be determined. The alteration may be determined based on the collected data. The alteration may be directed to the managed network or a portion thereof to resolve the anomaly. In some embodiments in which multiple underlying issues may cause the anomaly, as part of determination of the alteration, the actual underlying issue may be identified. The alteration may be determined to address the actual underlying issue.

At block 418, the alteration may be implemented. The alteration may be implemented in the managed network to resolve the anomaly. For instance, a control signal may be communicated to the managed endpoint that causes a change to a state of the managed endpoint (e.g., pushing a patch to the managed endpoint, enabling a firewall, changing power settings, deleting a log file, removing or updating a software application, etc.). Additionally or alternative, the alteration may include implementing a hardware change. For instance, the alteration may include generating and issuing a request for an additional piece of hardware or hardware component (e.g., issuing a request for a new battery, a different computing device, an additional monitor, etc.). Additionally or alternatively, the alteration may include initiation or progressing an automated HR workflow. For instance, the survey may include an exit survey. The additional information collected via the survey may be incorporated in an HR workflow that relies on the additional information. Accordingly, the additional information may be provided to an HR system for incorporation.

The method 400 may be performed by the management system 102 or the devices 106 described elsewhere in the present disclosure or by another suitable computing system, such as the computer system 300 of FIG. 3. In some embodiments, the management system 102, the devices 106, or the other computing system may include or may be communicatively coupled to a non-transitory computer-readable medium (e.g., the memory 312 of FIG. 3) having stored thereon programming code or instructions that are executable by one or more processors (such as the processor 310 of FIG. 3) to cause a computing system or the management system 102 or the devices 106 to perform or control performance of the method 400. Additionally or alternatively, the management system 102 or the devices 106 may include the processor 310 that is configured to execute computer instructions to cause the management system 102, the devices 106, or other computing systems to perform or control performance of the method 400. The management system 102, the devices 106, or the computer system 300 implementing the method 400 may be included in a cloud-based managed network, an on-premises system, or another suitable network computing environment. Although illustrated as discrete blocks, one or more blocks in FIG. 4 may be divided into additional blocks, combined into fewer blocks, or eliminated, depending on the desired implementation.

The embodiments described herein may include the use of a special purpose or general-purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data, which cause a general-purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the systems and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

The various features illustrated in the drawings may not be drawn to scale. The illustrations presented in the present disclosure are not meant to be actual views of any particular apparatus (e.g., device, system, etc.) or method, but are representations employed to describe embodiments of the disclosure. Accordingly, the dimensions of the features may be expanded or reduced for clarity. In addition, some of the drawings may be simplified for clarity. Thus, the drawings may not depict all of the components of a given apparatus (e.g., device) or all operations of a particular method.

Terms used in the present disclosure and the claims (e.g., bodies of the appended claims) are intended as “open” terms (e.g., the term “including” should be interpreted as “including, but not limited to,” the term “having” should be interpreted as “having at least,” the term “includes” should be interpreted as “includes, but is not limited to,” among others). Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in instances in which a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. Further, any disjunctive word or phrase presenting two or more alternative terms should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

The terms “first,” “second,” “third,” etc., are not necessarily used to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art and are to be construed as being without limitation to such specifically recited examples and conditions. Although embodiments of the present inventions have been described in detail, it should be understood that the various changes, substitutions, and alterations could be made hereto without departing from the scope of the invention.

What is claimed is:

1. A method of artificial intelligence (AI)-based system anomaly diagnosis and remediation, the method comprising:
receiving data from managed devices in a managed network, the data being indicative of device function and user interaction with managed devices;
discovering an anomaly in the data, the anomaly being indicative of an event experienced at a portion of the managed network;
using an AI engine, analyzing the anomaly and data related to the anomaly to determine additional information relevant to the anomaly that is not present in the received data;
generating, based on the AI engine, a data gathering mechanism to collect the additional information;
distributing the data gathering mechanism to one or more of the managed devices;
receiving collected data responsive to the distributed data gathering mechanism;
based on the collected data, determining an alteration to the managed network to resolve the anomaly; and
implementing the alteration in the managed network.

2. The method of claim 1, further comprising:
determining multiple different underlying issues that are a potential cause of the anomaly based on the analysis of the anomaly and data related to the anomaly; and
based on the collected data, identifying an actual underlying issue of the multiple different underlying issues that is the cause of the anomaly,
wherein the additional information includes data used to identify which of the multiple different underlying issues is the actual underlying issue that is the cause of the anomaly.

3. The method of claim 2, wherein the anomaly is indicative of a malfunctioning device or a suboptimal interaction by a user with one of the managed devices.

4. The method of claim 1, wherein the AI engine is trained on data of the managed network that is indicative of normal operation of the managed devices, optimal interaction of users relative to the managed devices, and optimal behavior of the managed devices.

5. The method of claim 1, wherein the discovering the anomaly in the data includes:
identifying a pattern of operations in one or more of the managed devices;
identifying a pattern of operations in a software that is running on one or more of the managed devices; or
identifying a pattern of interoperability data related to a product update.

6. The method of claim 1, wherein the data gathering mechanism includes:
a survey directed to one or more users who are associated with the anomaly; and
questions in the survey are directed to collection of the additional information.

7. The method of claim 1, further comprising submitting to an administrator the data gathering mechanism, wherein the distributing the data gathering mechanism is performed responsive to an indication of an approval received from the administrator.

8. The method of claim 1, wherein the data gathering mechanism includes:
an identification of one or more users or one or more of the managed devices that are directly affected by the anomaly; and
an identification of at least one request direct to the additional information.

9. The method of claim 1, wherein:
the anomaly is discovered prior to submission of a ticket in a service management system; and
the alteration is implemented proactively.

10. The method of claim 1, wherein the anomaly includes:
non-use of a licensed software;
a first user of a new hardware;
a modification of a role of a user in the managed network;
a new staff member;
a change in location of a user;
a repeated disabling of a firewall; or
a repeated malfunction of a device such as a periodic and repetitive low battery warning.

11. A non-transitory computer-readable medium having encoded therein programming code executable by one or more processors to perform or control performance of operations of artificial intelligence (AI)-based system anomaly diagnosis and remediation, the operations comprising:
receiving data from managed devices in a managed network, the data being indicative of device function and user interaction with managed devices;
discovering an anomaly in the data, the anomaly being indicative of an event experienced at a portion of the managed network;
using an AI engine, analyzing the anomaly and data related to the anomaly to determine additional information relevant to the anomaly that is not present in the received data;
generating, based on the AI engine, a data gathering mechanism to collect the additional information;
distributing the data gathering mechanism to one or more of the managed devices;
receiving collected data responsive to the distributed data gathering mechanism;
based on the collected data, determining an alteration to the managed network to resolve the anomaly; and
implementing the alteration in the managed network.

12. The non-transitory computer-readable medium of claim 11, wherein the operations further comprise:
determining multiple different underlying issues that are a potential cause of the anomaly based on the analysis of the anomaly and data related to the anomaly; and
based on the collected data, identifying an actual underlying issue of the multiple different underlying issues that is the cause of the anomaly,
wherein the additional information includes data used to identify which of the multiple different underlying issues is the actual underlying issue that is the cause of the anomaly.

13. The non-transitory computer-readable medium of claim 12, wherein the anomaly is indicative of a malfunctioning device or a suboptimal interaction by a user with one of the managed devices.

14. The non-transitory computer-readable medium of claim 11, wherein the AI engine is trained on data of the managed network that is indicative of normal operation of the managed devices, optimal interaction of users relative to the managed devices, and optimal behavior of the managed devices.

15. The non-transitory computer-readable medium of claim 11, wherein the discovering the anomaly in the data includes:
identifying a pattern of operations in one or more of the managed devices;
identifying a pattern of operations in a software that is running on one or more of the managed devices; or
identifying a pattern of interoperability data related to a product update.

16. The non-transitory computer-readable medium of claim 11, wherein the data gathering mechanism includes:
a survey directed to one or more users who are associated with the anomaly; and
questions in the survey are directed to collection of the additional information.

17. The non-transitory computer-readable medium of claim 11, wherein:
the operations further comprise submitting to an administrator the data gathering mechanism; and
the distributing the data gathering mechanism is performed responsive to an indication of an approval received from the administrator.

18. The non-transitory computer-readable medium of claim 11, wherein the data gathering mechanism includes:
an identification of one or more users or one or more of the managed devices that are directly affected by the anomaly; and
an identification of at least one request direct to the additional information.

19. The non-transitory computer-readable medium of claim 11, wherein:
the anomaly is discovered prior to submission of a ticket in a service management system; and
the alteration is implemented proactively.

20. The non-transitory computer-readable medium of claim 11, wherein the anomaly includes:
non-use of a licensed software;
a first user of a new hardware;
a modification of a role of a user in the managed network;
a new staff member;
a change in location of a user;
a repeated disabling of a firewall; or
a repeated malfunction of a device such as a periodic and repetitive low battery warning.
